(19) United States
(12) Patent Application Publication
(10) Pub. No.: US 2026/0146742 A1
(43) Pub. Date: May 28, 2026

(54) Food Product Representative, Process and Cooking Appliance for Efficient Cooking Chamber Unloading with Mixed Loading

(71) Applicant: RATIONAL Aktiengesellschaft, Landsberg am Lech (DE)

(72) Inventors: Fabian Heß, Landsberg am Lech (DE); Florian HARTMANN, Landsberg am Lech (DE); Rainer STORHAS, Landsberg am Lech (DE)

(21) Appl. No.: 19/396,576

(22) Filed: Nov. 21, 2025

(30) Foreign Application Priority Data
Nov. 22, 2024 (DE) 10 2024 134 484.9

(51) Int. Cl. F24C 7/08; A23L 5/10; A47J 36/32

(52) U.S. Cl. CPC F24C 7/085; A23L 5/10; A47J 36/32

(57) ABSTRACT

The present disclosure relates to a representative of a food product to be cooked in a cooking chamber of a cooking appliance with a cooking program, in the form of a virtual ticket, which is configured to be displayable in a display area of a display device, in particular of the cooking appliance, relative to a time axis for visualizing a cooking time, wherein the ticket extends in length from a start time at which the represented food product is to be loaded into the cooking chamber to an end time at which the represented food product is to be unloaded from the cooking chamber to achieve a set cooking result, so that the cooking time is obtained from the difference between the end time and the start time. A tolerance band may be determined for the end time as a function of at least one overlap factor, where the overlap factor is a percentage amount of the cooking time which defines a cooking time reduction range that can be subtracted from the cooking time and/or a cooking time extension range that can be added to the cooking time, and the tolerance band comprises the cooking time reduction range and/or the cooking time extension range.

### CROSS-REFERENCE TO RELATED APPLICATION

This application claims priority to German Patent Application No. DE 10 2024 134 484.9, filed on Nov. 22, 2024, the entirety of which is incorporated herein by reference.

### Field

The present disclosure relates to a representative of a food product to be cooked in a cooking chamber of a cooking appliance with a cooking program, in the form of a virtual ticket, which is configured to be displayable in a display area of a display device, in particular of the cooking appliance, relative to a time axis for visualizing a cooking time, wherein the ticket extends in length from a start time at which the represented food product is to be loaded into the cooking chamber to an end time at which the represented food product is to be unloaded from the cooking chamber to achieve a set cooking result, so that the cooking time results from the difference between the end time and the start time. It also relates to a method for displaying the unloading of food products from a cooking chamber of a cooking appliance that can be closed with a door using such representatives, and a cooking appliance for carrying out such a method.

### BACKGROUND

Various methods for operating cooking appliances are known. In the prior art, representatives for cooking programs are often used to display a function plan or even a current operation. Such cooking program representatives are also called virtual tickets or simply tickets.

For example, WO 2012/117100 A2 discloses a method for operating at least one cooking appliance with a cooking chamber, an input device, a display device, and a storage device, in which a plurality of work programs for the cooking appliance can be retrieved from the storage device, including a time characteristic for executing each work program, which is determined not only by the duration of the work program but also by a preparation time for preparing the execution of the work program and/or a follow-up time for following up on the execution of the work program. It is essential that a representative of each stored work program can be displayed on the display device, whereby the respective associated time is also displayed for each representative displayed.

Furthermore, DE 10 2014 106 676 A1 describes a method for creating a schedule for the operation of a cooking appliance with an energy storage device for storing thermal energy and for releasing thermal energy, a food product treatment device for treating food products in a cooking process, a cooking process storage device for storing a plurality of cooking processes, an input device for selecting cooking processes, and a control or regulation device for controlling selected cooking processes. The method comprises the following steps: selecting at least two cooking processes from the plurality of cooking processes, wherein each cooking process is retrieved with at least a first parameter of a food product treatment and at least a second parameter of an energy consumption from the cooking process storage device, determining the charge state of the energy storage device and determining the temporal sequence of the selected cooking processes as a function of at least the second parameters of the selected cooking processes and the charge state of the energy storage device.

DE 10 2010 036 639 A1 discloses a generic representative of at least one section of a program that can be executed in a cooking appliance, which can be arranged in the display area of a display device relative to a time axis characteristic of the operation of at least one cooking appliance in order to visualize the section, wherein at least one extension of the representative parallel to the time axis is characteristic of a duration of the section. According to DE 10 2010 036 639 A1, the extension parallel to the time axis automatically adapts to any change in the time required for the section during the course of the same, which results from a determination of the time required carried out at at least two, preferably a plurality of, points in time during the course of the section, in order to visualize the inaccuracy of the determination of the time required.

DE 10 2019 121 443 B3 deals with a method for visualizing a program planning using program representatives.

EP 2 860 460 A1 discloses a method for operating a cooking appliance which has a display and control panel in the form of a touch screen on which display and control buttons can be displayed so that inputs can be generated in the appliance control system by touching the displayed buttons.

DE 10 2009 006 182 A1 describes a method for arranging representatives of programs selected from a plurality of programs for cooking appliances via at least one input device on at least one display device that is operatively connected to the input device and a control or regulation device.

There is still a need for an intelligent solution for the efficient unloading of food products at the end of cooking in mixed loading, i.e., loading a cooking chamber with different food products at different times, as is common in à la carte restaurant operations. In such mixed loading, which requires a so-called mixed operation of a cooking appliance, several food products are usually processed simultaneously at specific times or over specific periods of time. Due to different cooking times for the respective food products, which result in particular from user settings and/or load surcharges, a cooking appliance user is prompted separately for each cooking shelf to unload the cooking chamber at the end of cooking. This can result in tickets prompting the user to unload certain cooking shelfs, even if seconds earlier the user was already prompted to unload another cooking shelf via the ticket assigned to it. This results in avoidable interactions with the appliance for the user. Furthermore, additional heating pulses are generated that are not absolutely necessary and are therefore not energy-efficient.

For example, if ticket 1 prompts the user to unload and a cooking program for another ticket 2 still has 5 seconds remaining at this point, the user opens the door of the device, removes the food products assigned to ticket 1, closes the door, and then 5 seconds later receives a prompt via ticket 2 to open the door again for unloading.

### SUMMARY

An object of the present disclosure is to further develop the generic representative in such a way that the disadvantages of the prior art are overcome.

This object may, for example, be solved by determining a tolerance band for the end time as a function of at least one overlap factor, wherein the overlap factor is a percentage amount of the cooking time, which defines a cooking time reduction range that can be subtracted from the cooking time and/or a cooking time extension range that can be added to the cooking time, and the tolerance band comprises the cooking time reduction range and/or the cooking time extension range

It may be that the overlap factor depends on at least a first variable relating to the climate in the cooking chamber, such as determined by the temperature, humidity, flow velocity, and/or pressure in the cooking chamber, at least one second variable relating to the type of the food product, such as poultry, meat, fish, egg dishes and desserts, vegetables and side dishes, or baked goods, at least one third variable relating to the cooking mode, such as hot air, steam, and/or microwaves, at least one fourth variable relating to the sensitivity, size, quantity, and/or condition, in particular pre-cooked, frozen, or fresh, of the food product, at least a fifth variable relating to the degree of cooking, such as determined by core temperature, browning, and/or crusting, at least a sixth variable relating to the cooking appliance, such as determined by the dimensions of the cooking chamber, an accessory, in particular in the form of a cooking tray, a climate zone in the area of the food product in the cooking chamber and/or a resource consumption, in particular determined by energy consumption, and/or at least a seventh variable relating to the cooking method, such as à la carte cooking, regeneration, or finishing.

It is also proposed that a default value for the overlap factor is specified for the first, second, third, fourth, fifth, sixth, and/or seventh variable, whereby the default value can be changed.

Furthermore, it may be provided that the overlap factor is up to 8% of the cooking time, whereby in particular a mean value of 5% can be specified and/or changed.

It is also proposed that no perceptible sensory and hygienic impairments of the cooking result of the food products unloaded from the cooking chamber are perceptible within the tolerance band.

The present disclosure also relates to a method for indicating the unloading of a cooking chamber of a cooking appliance that can be closed with a door, wherein at least two food products are cooked at least temporarily simultaneously in the cooking chamber and each food product has assigned a representative in the form of a virtual ticket in accordance with embodiments, which is displayed on a display area of a display device along a time axis in the x-direction.

It may be that n shelf levels and/or m cooking zones are provided in the cooking chamber, and that the n shelf levels are displayed along the y-direction and/or the m cooking zones are displayed along the z-direction in the display area, wherein n and/or m belong to the natural numbers of 2 and more.

According to embodiments, it is preferred that for each ticket, an unloading information and/or an unloading request is displayed and/or output at an unloading time, and/or for each ticket, the cooking time reduction range and/or the cooking time extension range is displayed, at least upon request.

It is further proposed that, when the tolerance bands of at least two tickets overlap along the x-axis, a common unloading time is determined, in particular by simple averaging, weighted averaging depending on the first, second, third, fourth, fifth, sixth, and/or seventh variable, selection of the earliest possible unloading time for said at least two tickets or selecting the latest possible unloading time for said at least two tickets.

According to embodiments, it may also be that an energy saving setting can be used to determine the overlap factor, in particular via an adjustment controller.

Furthermore, it may be that a sensitivity for determining the overlap factor can be set, in particular by selecting one of several sensitivity levels.

Finally, the disclosure also proposes a cooking appliance with a cooking chamber that can be closed by a door and comprises n shelf levels and/or m cooking zones, where n and/or m belong to the natural numbers of 2 and more, and with a display device comprising a display area in which representatives of food products to be cooked in the cooking chamber with a cooking program are displayed on a virtual ticket board with a time axis in the x-direction and a shelf level axis in the y-direction and/or a cooking zone axis in the z-direction in the form of virtual tickets according to embodiments.

It can that end times for the food products can be determined in a method according to embodiments.

The present disclosure is thus based on the surprising perception that a device control system can determine a time window of, for example, 5% of the remaining cooking time of a total cooking time of a cooking program (ticket 2) for a food product 2 to be cooked and defines it as a period of time, namely as a cooking time reduction range, within which said food product 2 can be unloaded simultaneously with another food product 1, the ticket 1 of which has already started an unloading request. It is also possible that the total cooking time of the cooking program for ticket 1 is extended by a certain period of time, namely by a cooking time extension range, so that food products 1 can be unloaded together with food product 2 after the end of its total cooking time. According to embodiments, an aim is to postpone unloading to a time when several food products can be unloaded simultaneously. The period of time specified for each food product can be linked to its sensitivity. For example, a sensitive food product may have a lower tolerance band than an insensitive food product, determined, for example, by 1% of the remaining cooking time of its total cooking time.

It is also possible to specify an average value for the percentage of the remaining cooking time, e.g., 3%, and to make this average value adjustable. For example, the tolerance range for calculating the average value can be adjusted using a slider for energy saving or predefined sensitivity levels.

In this case, tickets for sensitive food products may only allow the tolerance band to be shifted in one direction, for example, if thorough cooking must be guaranteed for hygiene reasons or if overcooking should be avoided for taste or aesthetic reasons. This information can be stored in a ticket, making it easier to take it into account when calculating the average value.

It may also be possible for the cooking appliance user or restaurant owner to select on the cooking appliance whether they a cooking in a more energy-efficient manner, which increases the percentage of the remaining cooking time, resulting in fewer door openings, is wished.

The method according to embodiment of the disclosure thus prevents unnecessary device interactions and heating requirements. The user of a cooking appliance is then no longer burdened with unnecessary door opening/closing requests and associated ring tones in everyday kitchen use. Sustainability is also increased through energy savings, namely by avoiding short heating cycles that have little or no relevance to food product cooking. At the same time, overcooking of food products is avoided by ensuring that food products the cooking programs of which are represented by tickets that have not yet expired are not exposed to energy that could lead to overcooking in the last seconds of their cooking time when other food products are unloaded, even when the door is open.

Thus, embodiment of the disclosure make it possible to reduce the workload, save energy/resources, and improve the quality of cooking in mixed loads.

### BRIEF DESCRIPTION OF THE DRAWINGS

Further features and advantages of the invention are apparent from the following description, in which embodiments of the invention are explained in detail with reference to schematic drawings, which show:

FIG. 1 the size of an overlap factor for reducing and/or extending the cooking time as a function of the temperature in the cooking chamber, which is plotted on the x-axis, and the humidity in the cooking chamber, which is plotted on the y-axis;

FIGS. 2a-2c a ticket with a tolerance band based on an overlap factor, without a visualized tolerance band, with a visualized tolerance band for reducing the cooking time, and with a visualized tolerance band for both shortening and extending the cooking time, respectively.

FIGS. 3a-3c an adjustment controller for setting an energy saving, in its initial position, in a position with high energy saving together with the corresponding ticket, and in a position with low energy saving together with the corresponding ticket, respectively; and

FIGS. 4a-4c an adjustment controller for setting an energy saving and ten tickets for ten shelf levels of a cooking appliance along a time axis, for a setting with no energy savings, for a setting with high energy savings, with tolerance bands and with tolerance bands and earliest and latest unload times, respectively.

### DETAILED DESCRIPTION

In the context of the present disclosure, the term “overlap factor” is defined as a percentage amount of a cooking time of a food product to be cooked, such as 5% of the remaining cooking time of a total cooking time of a cooking program for a food product. This overlap factor defines the period of time that can be deducted from a specified, optimal cooking time for the food product and/or added to the specified, optimal cooking time for the food product without noticeable deficits in sensory and hygienic cooking results. The overlap factor therefore determines a period of time, similar to a tolerance band, within which the cooking time can be reduced and/or extended.

An overlap factor of 5% ensures that 95% of the energy planned for a cooking program acts directly on the food product. This value achieves a sufficient balance between internal and external cooking on average, so that the food product is cooked to the desired extent without overcooking or undercooking.

However, depending on the climate conditions in the cooking chamber, the type of food product, and the cooking method, it may be advisable to adjust the overlap factor to specific requirements.

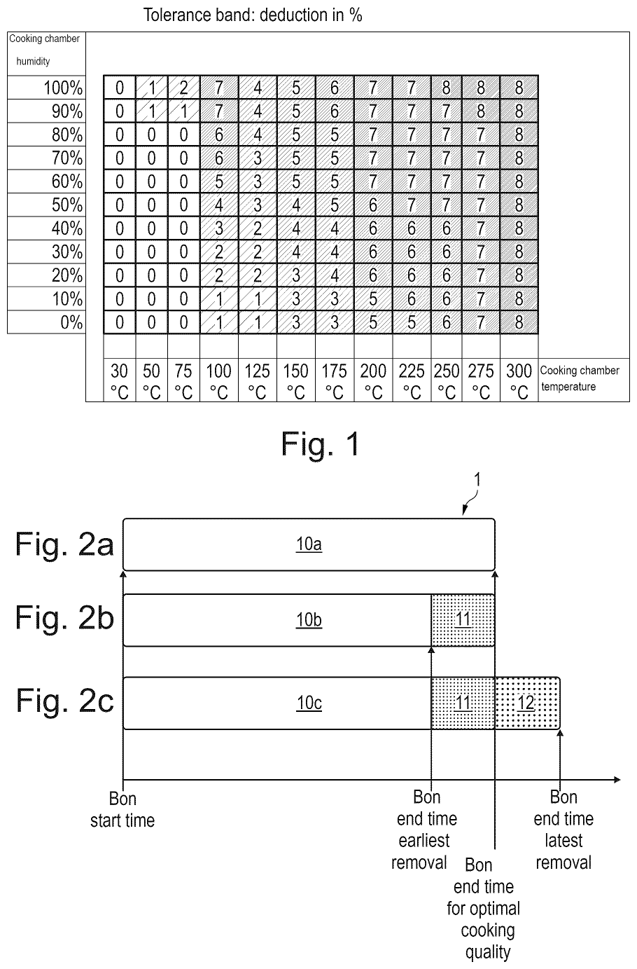

The climate in the cooking chamber can lead to a variance of 0 to 8% in the overlap factor, as shown in FIG. 1. This is explained below using examples:
Up to 8% overlap factor
   At temperatures above 200° C. (dry climate) in a cooking chamber, combined with high fan speeds during cooking processes such as grilling, quick frying, or crusting, a high amount of energy is transferred from the surface of a food product to its core. Even when the door of the cooking chamber is opened, interrupting the cooking process, this energy transfer will continue for a certain amount of time.
      For a rump steak (approx. 250 g) and a cooking time of 9 minutes (540 s), the cooking process could be completed after just 497 s within the tolerance range of 8% without any noticeable sensory deficits in the food product.
      The situation is similar when steaming food products at boiling temperature. Condensing steam transfers enormous amounts of energy, so a tolerance band of up to 8% can also be applied here.
Up to 1% overlap factor
At temperatures well below 100° C. and low humidity, e.g., 60° C. and 20% humidity, relatively little energy is transferred, which also ceases immediately after the cooking process is completed. Areas of application include dry fermentation (letting macarons “rest”) or gentle drying of pasta.

However, the food products as such can also lead to a variance of 0 to 8% in the overlap factor. This will be explained again below using examples:
Between 1-7% overlap factor
   Animal proteins: Food products that consist mainly of protein, such as meat, fish, and poultry, require a relatively small overlap factor in the range of 2-4%. The reason for this is that these food products require a certain amount of internal cooking in order to achieve the desired degree of doneness and to ensure microbial safety at the end of the cooking process.
   Legumes/cereals (sweet grasses): Food products such as lentils, beans, or rice require an overlap factor of <5% due to their small size, as the energy input quickly dissipates after the end of cooking and the firmness of these food products significantly defines the perceived cooking quality.
   Starchy food products such as potatoes: These food products are prepared with an overlap factor greater than 5%. The reason for this is their relatively large volume and the resulting large energy storage capacity after cooking. Due to their long cooking time, these food products are often pre-cooked for à la carte situations, so the focus here is more on the reheating process.
   Egg food products: Food products containing eggs, such as quiches, scrambled eggs, and even shell eggs, require a narrow overlap factor of 1-3%, as it is desirable to denature the egg proteins optimally so that they set. Although this is primarily achieved by precisely controlling the cooking chamber climate, the time aspect also plays a role, as the applied temperature reaches the core of the food products with a time delay.

Furthermore, there are the applications that can lead to a variance of 0 to 8% in the overlap factor. This will also be explained below using examples:
Up to 5-7% overlap factor
À la carte cooking: In typical à la carte situations, food products are cooked à la minute so that they can be served in 10-20 minutes. Depending on the number of orders, this can be very stressful in a kitchen. Here, it is important that individual components can be unloaded at the same time and unnecessary interactions with the appliance, such as opening the door, can be avoided. During these phases, a chef will not stand in front of the appliance and wait for it to “finish.” On the contrary, there will be phases where the appliance rings for seconds to request unloading, and unloading is delayed. In this case, it makes sense to unload also other food products items immediately if they are within the tolerance range. Undercooking is not to be expected.
Up to 5-8% overlap factor
Regenerating/finishing: When regenerating or finishing food products, especially pre-cooked dishes, the overlap factor can also be interpreted more generously. Small food products that have already reached their internal cooking degree can have a higher overlap factor. This also applies to large food products such as gratins, casseroles, or roasts, which can also tolerate a larger tolerance band, as the final temperature differences have no significant impact on food products quality. Since these food products are already pre-cooked, precise timing is not as critical as it is for fresh food products.

A cooking appliance such as the applicant's iCombi Pro can be used with appliance intelligence to implement a method according to embodiments. This appliance intelligence determines and/or weights within the cooking process, based on the control variables resulting from user selection, such as cooking chamber climate through cooking process selection, food products settings through food products-dependent cooking process selection, and cooking function through the use of typical finishing or à la carte applications, and applies it as appropriate to the situation.

By using further evaluations of a current cooking process, such as an increase (behavior) in food product core temperatures or a target and actual comparison of the cooking chamber temperature, the overlap factor can be (further) adjusted. If, for example, it is detected that the cooking chamber temperature is below a target temperature, the overlap factor can be reduced to prevent undercooking.

Example embodiments of the invention are described in the following using virtual tickets, the length of which represents the cooking time of a cooking program.

FIGS. 2a, 2b, and 2b each show one and the same ticket 10 in a display area 1 with a longitudinal extension along a time axis, so that a start time and an end time of the cooking program assigned to ticket 10 are visualized. FIG. 2a shows ticket 10a with its optimal cooking time, which results in optimal cooking quality. In FIG. 2b, ticket 10b comprises a first marked area that visualizes a cooking time reduction area 11 determined for this ticket 10b via its assigned overlap factor; and in FIG. 2c, ticket 10c includes, in addition to its cooking time reduction area 11, a second marked area that visualizes a cooking time extension area 12 determined for this ticket 10 via its assigned overlap factor.

The tickets 10 can be displayed in the display area 1 of a display device of the cooking appliance as tickets 10a, 10b, 10c, each with its optimal cooking time, while the tolerance bands determined by the cooking time reduction range 11 and/or the cooking time extension range 12 are stored in the ticket and thus in the cooking appliance, but are not displayed or are only displayed on request.

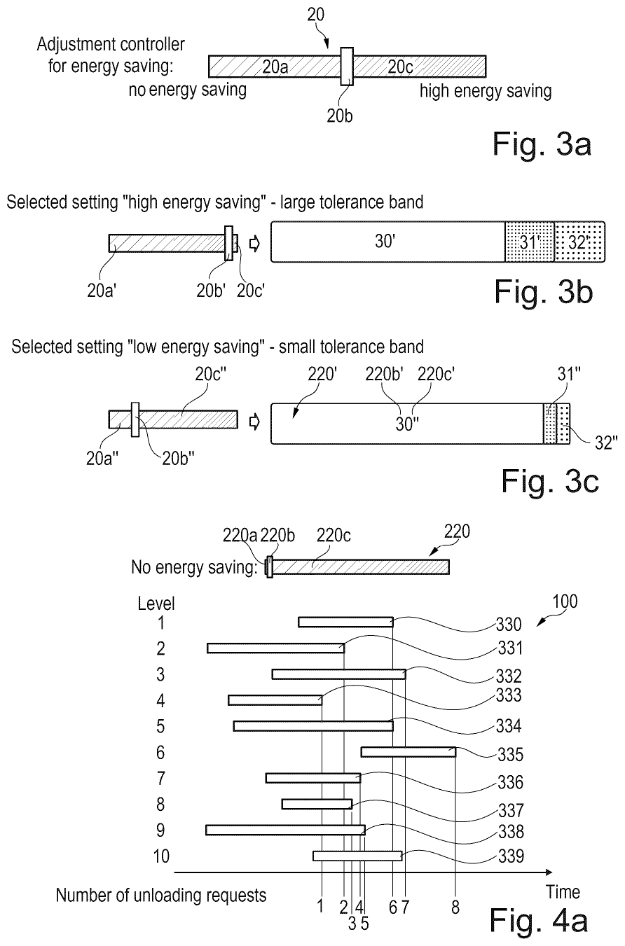

FIG. 3a shows a virtual adjustment controller 20 for setting energy an saving, such as displayed on a display area, so that a user of the cooking appliance can set where in a range 20a with low energy savings and a range 20c with high energy savings a slider 20b is to be placed by touching and moving it into one or the other range 20a or 20c. FIG. 3b shows the adjustment controlerl 20′ after moving the slider 20b′ to the right, so that the slider 20b′ is located in the range 20c′ with high energy savings, which has a direct effect on a ticket 30′ shown next to it, which thereby obtains large tolerance bands for both its cooking time reduction range 31′ and its cooking time extension range 32′. If, on the other hand, the slider 20b″ is moved to the left, as shown in FIG. 3c, i.e., into the range 20a″ of low energy savings, the tolerance bands of the ticket 30″ are reduced, since both the cooking time reduction range 31″ and the cooking time extension range 32″ must be shortened.

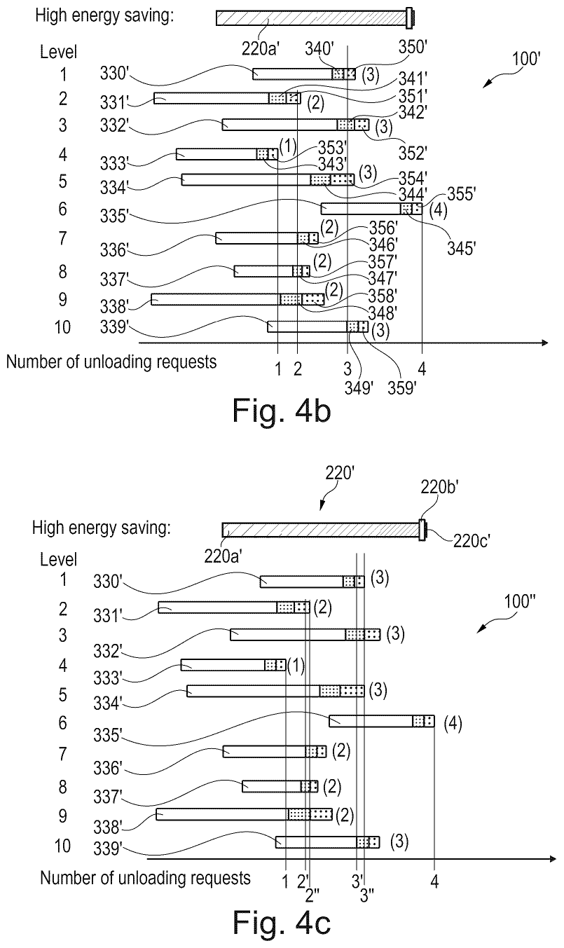

FIGS. 4a to 4c each show a display area 100, 100′, 100″ of a cooking appliance that has ten shelf levels, each with a cooking zone, plotted along the y-axis, while time is plotted along the x-axis. Also visible are an adjustment controller 220, 220′ for setting energy savings and ten tickets 330-339, 330′-339′, with one ticket assigned to each shelf level to visualize à la carte operation, in which ten different food products are loaded into and unloaded from the cooking chamber of the cooking appliance over the time period shown.

FIG. 4a shows a configuration in which no energy saving is selected via the adjustment controller 220, i.e., the slider 220b is positioned at the far left, at the end of the range 220a with low energy saving. Furthermore, the ten tickets 330 to 339 are arranged in such a way that unloading and opening the cooking chamber door is necessary eight times, as there are no tolerance bands. Accordingly, the first food product to be unloaded is the one corresponding to ticket 333 in shelf level 4, the second food product corresponds to ticket 331 in shelf level 2, the third food product corresponds to ticket 337 in shelf level 8, the fourth food product corresponds to ticket 336 in shelf level 7, the fifth food product corresponds to ticket 338 in shelf level 9, the sixth food products correspond to tickets 330 and 334 in shelf levels 1 and 5, respectively, the seventh food products correspond to tickets 332 and 339 in shelf levels 3 and 10, respectively, and as the eighth food product corresponds to ticket 335 in shelf level 6. Thus, only at times 6 and 7 two food products are unloaded, since their respective cooking times expire essentially simultaneously, while for all other food products a single unloading takes place, with unloading times 2, 3, 4, and 5 having only slight time intervals. At each of the eight unloading times 1 to 8, an unloading request is issued by the cooking appliance, e.g., in the form of a ring tone.

FIG. 4b differs from FIG. 4a in that maximum energy savings are selected via the adjustment controller 220′, i.e., the slider 220b′ is positioned at the far right, at the end of the range 220b′ with high energy savings. The ten tickets 330′ to 339′ are arranged in FIG. 4b in the same order as in FIG. 4a, but the respective tolerance bands of tickets 330′ to 339′ are also shown via the corresponding cooking time reduction ranges 340′-349′ and cooking time extension ranges 350′-359′ due to the high energy saving setting. This reduces the number of unloading times from eight in FIG. 4a to four in FIG. 4b, which are determined by the overlap of the tolerance bands of tickets along the time axis, for example, over the smallest possible distance between the unloading times and the mean values of the respective ideal cooking times.

In the constellation shown in FIG. 4b, the following unloadings take place at the four unloading times:
Unloading time 1:
No combinable level is available for level 4, as there is no tolerance band overlap.
Unloading time 2:
Earliest possibility for unloading determined by level 7, could be postponed until the end of level 2, and includes levels 2, 8, and 9 in addition to level 7.
Unloading time 3:
Determined by level 10, whereby the exact time can be postponed by calculating the average tolerance distances to levels 1, 3, 5, and 10.
Unloading time 4:
There is no combinable level for level 6, so that unloading is only planned there.

FIG. 4c differs from FIG. 4b only in that, for unloading times 3 and 4, at which unloading can take place in several levels, the earliest unloading time is marked with ′ and the latest unloading time is marked with ″. The unloading times in FIG. 4b were calculated by averaging.

All settings between those shown in FIG. 4a without energy saving and those shown in FIGS. 4b and 4c with maximum energy saving are conceivable, so that the eight unloading times in FIG. 4a can gradually be reduced to the four unloading times. For example, an average energy saving can be achieved with six unloading times, which already leads to a reduction in workload without any loss of cooking quality, in addition to the energy saving.

The features of the invention disclosed in the foregoing description, the drawings, and the claims may be essential for the realization of the invention in its embodiments, either individually or in any combination.

### LIST OF REFERENCE SIGNS

1 display area
10, 10a, 10b, 10c ticket
11 cooking time reduction range
12 cooking time extension range
20 adjustment controller
20 a, 20a′, 20a′ range with low energy savings
20b, 20b′, 20b″ slider
20c, 20c′, 20c″ area with high energy savings
30′, 30″ ticket
31′, 31″ cooking time reduction range
32′, 32″ cooking time extension range
100, 100′, 100″ display range
220, 220′ adjustment controller
220 a, 220a′ range with low energy savings
220b, 220b slider
220 c, 320c′ area with high energy savings
330-339, 330′-339′ Ticket
340-349 cooking time reduction range
350′-359′ cooking time extension range

1. A virtual ticket representative of a food product to be cooked in a cooking chamber of a cooking appliance with a cooking program, which is configured to be displayable in a display area of a display device of the cooking appliance, relative to a time axis for visualizing a cooking time, wherein the virtual ticket extends in length from a start time, at which the represented food product is to be loaded into the cooking chamber, to an end time, at which the represented food product is to be unloaded from the cooking chamber to achieve a set cooking result, so that the cooking time results from the difference between the end time and the start time, characterized in that
a tolerance band is determined for the end time as a function of at least one overlap factor,
wherein the overlap factor is a percentage amount of the cooking time, which defines a cooking time reduction range that can be subtracted from the cooking time and/or a cooking time extension range that can be added to the cooking time, and the tolerance band comprises the cooking time reduction range and/or the cooking time extension range.

2. The virtual ticket according to claim 1, characterized in that the overlap factor depends on
at least a first variable relating to the climate in the cooking chamber, determined by the temperature, humidity, flow velocity, and/or pressure in the cooking chamber,
at least one second variable relating to the type of the food product,
at least one third variable relating to the cooking mode,
at least one fourth variable relating to the sensitivity, size, quantity, and/or condition of the food product,
at least a fifth variable relating to the degree of cooking, determined by core temperature, browning, and/or crusting,
at least a sixth variable relating to the cooking appliance, determined by the dimensions of the cooking chamber, a cooking tray, a climate zone in the area of the food product in the cooking chamber and/or a resource consumption, determined by energy consumption, and/or
at least a seventh variable relating to the cooking method.

3. The virtual ticket according to claim 2, characterized in that a default value of the overlap factor is specified for the first, second, third, fourth, fifth, sixth, and/or seventh variable, wherein the default value is changeable.

4. The virtual ticket according to claim 1, characterized in that the overlap factor is up to 8% of the cooking time, whereby a mean value of 5% can be specified and/or is changeable.

5. The virtual ticket according to claim 1, characterized in that no perceptible sensory and hygienic impairments of the cooking result of the food product unloaded from the cooking chamber are perceptible within the tolerance band.

6. A method for indicating the unloading of a cooking chamber of a cooking appliance that can be closed with a door, comprising:
cooking at least two food products at least temporarily simultaneously in the cooking chamber; and
assigning each food product a representative in the form of a virtual ticket in accordance with claim 1, which is displayed on a display area of a display device along a time axis in the x-direction.

7. The method according to claim 6, characterized in that
n shelf levels and/or m cooking zones are provided in the cooking chamber, and
in the display area, the n shelf levels are displayed along the y-direction and/or the m cooking zones are displayed along the z-direction, wherein n and/or m belong to the natural numbers of 2 and more.

8. The method according to claim 6, characterized in that
for each ticket, an unloading information and/or an unloading request is displayed and/or output at an unloading time, and/or
for each ticket, the cooking time reduction range and/or the cooking time extension range is displayed, at least upon request.

9. The method according to claim 6, characterized in that
when the tolerance bands of at least two tickets overlap along the x-axis, a common unloading time is determined by simple averaging, weighted averaging depending on the first, second, third, fourth, fifth, sixth, and/or seventh variable, selection of the earliest possible unloading time for said at least two tickets or selecting the latest possible unloading time for said at least two tickets.

10. The method according to claim 6, characterized in that an energy saving setting can be used to determine the overlap factor via an adjustment controller.

11. The method according to claim 6, characterized in that a sensitivity for determining the overlap factor can be set by selecting one of several sensitivity levels.

12. A cooking appliance, comprising:
a cooking chamber that can be closed by a door and comprises n shelf levels and/or m cooking zones, where n and/or m belong to the natural numbers from 2 and above; and
a display device that comprises a display area in which representatives of food products to be cooked in the cooking chamber with a cooking program are displayed on a virtual ticket board with a time axis in the x-direction and a shelf level axis in the y-direction and/or a cooking zone axis in the z-direction in the form of virtual tickets according to claim 1.

13. The cooking appliance according to claim 12, characterized in that unloading times for the food products are determined by a method comprising:
cooking at least two food products at least temporarily simultaneously in the cooking chamber; and
assigning each food product a representative in the form of a virtual ticket, which is displayed on a display area of a display device along a time axis in the x-direction.
